(19) United States
(12) Patent Application Publication
(10) Pub. No.: US 2007/0186867 A1
(43) Pub. Date: Aug. 16, 2007

(54) Portable handheld animal groomer

(76) Inventor: Greg Mulloy, Oklahoma, OK (US)

Correspondence Address: MICHAEL RIES, 318 PARKER PLACE, OSWEGO, IL, 60543, US

(21) Appl. No.: 11/705,287

(22) Filed: Feb. 12, 2007

Related U.S. Application Data
(60) Provisional application No. 60/766,820, filed on Feb. 13, 2006.

(51) Int. Cl. A01K 13/00

(52) U.S. Cl. 119/601; 119/609

(57) ABSTRACT

The present invention is a handheld portable battery operated groomer used in the safe removal of the nails on dogs and cats. The present invention will use a grinding method in which to accomplish this. The present unit will have a small, one or two-speed motor, which will drive a concave grinding stone. This will safely remove the nail surface, either slowly at low speed 2000-2800 rpm or faster at higher speed 3000-4000 rpm.

This application claims the benefit of U.S. Provisional Patent Application Ser. No. 60/766,820, filed Feb. 13, 2006.

### TECHNICAL FIELD & BACKGROUND

The present invention generally relates to the field of portable handheld dog and cat nail or beak groomers. More specifically, the present invention relates to a portable handheld groomer of cylindrical shape with a concave grinding stone.

The present invention may be approximately 6″ long and 1½″ wide, but not limited to these dimensions. The present invention is small enough to fit in a person's hand for one-handed operation. The present invention will have a body that can be made of various materials, including but not limited to plastic, aluminum, copper, steel or iron with a cover at the top that covers the grinding stone, but allows access to the stone through an opening. This cover may or may not be removable. The present intention will have a removable concave stone either to choose a different degree of coarseness or to replace the stone with a new stone. The bottom of the unit may or may not be removable and houses an energy source or battery. The bottom may be removable to allow replacement of the battery.

The present invention is to be a multi-use as opposed to single use device but can also be made to be a disposable one-time use unit. There will be a “concaved” grinding stone in the present invention made of a coarse, abrasive material of, but not limited to, sand, aluminum oxide, ceramic, silicon carbide or zirconium oxide, for removal of the nail or beak. Currently to remove the nail another's method is to use a “clipper”. This other method can invariably harm the animal if a person clips the nail too close to the “quick” or “bloodline” of the nail. The present invention will be portable so one can trim their pet's nails slowly at their leisure. Within the body of the present unit will be a small two-speed motor, which will rotate at a speed that is safe for the animal. The intended speed for the slowest speed of the present invention will be between 2000 and 2800 rpm and the intended speed for the second and faster speed will be between 3000 and 4000 rpm.

All the components in the present invention will be assembled together to allow the unit to function. The present invention will have a switch on the outer housing of the unit to turn it on to the low speed or the fast speed. In the present invention if a small two-speed motor were not available, a single speed motor could be used, and the amount of nail removed from the pet would be determined by the coarseness of the stone used. The intended speed of the single speed motor in the present invention will be between 2500 and 3500 rpm. The present invention can also be used to trim the beaks and claws of birds, such as parrots, parakeets, etc.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a drawing of a front view of a groomer, in accordance with one embodiment of the present invention;

FIG. 2 illustrates a perspective view of a of the present invention with a cover dashed for clarity and a concave grinding stone in operation, in accordance with one embodiment of the present invention;

FIG. 3 illustrates a perspective view of a groomer in use, in accordance with one embodiment of the present invention;

FIG. 4A illustrates a drawing of a close up of an animal paw nail before the present invention is used to groom, in accordance with one embodiment of the present invention;

FIG. 4B illustrates a drawing of a close up of an animal paw nail after the present invention is used to groom by safely removing a nail by grinding a nail surface either slowly at low speed or faster at high speed without harming the nail quick, in accordance with one embodiment of the present invention; and

FIG. 5 illustrates a drawing of an exploded front view showing the component parts, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

The present invention is a portable handheld groomer that features a concave grinding stone, which will trim the nails of the pet very similar to that of a human finger so that the nail is rounded. The present invention can be used on dog and cat nails or bird beaks and claws of various animals. The present invention will, as mentioned, have one or two speeds, which can be used to trim the nails as the pet owner sees fit. The present invention will also have different degrees of coarseness of the concave grinding stone which will be removable and replaceable the coarseness chosen will depend on the condition of the animal's nails. The present invention will be operated by at least a single battery to make the groomer portable so the owner has more flexibility to groom his pet.

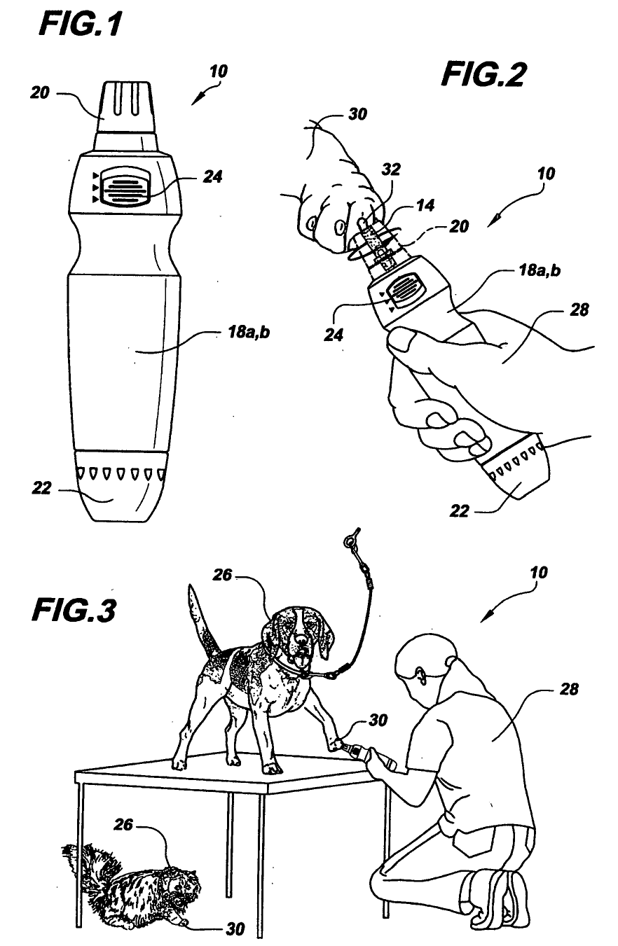

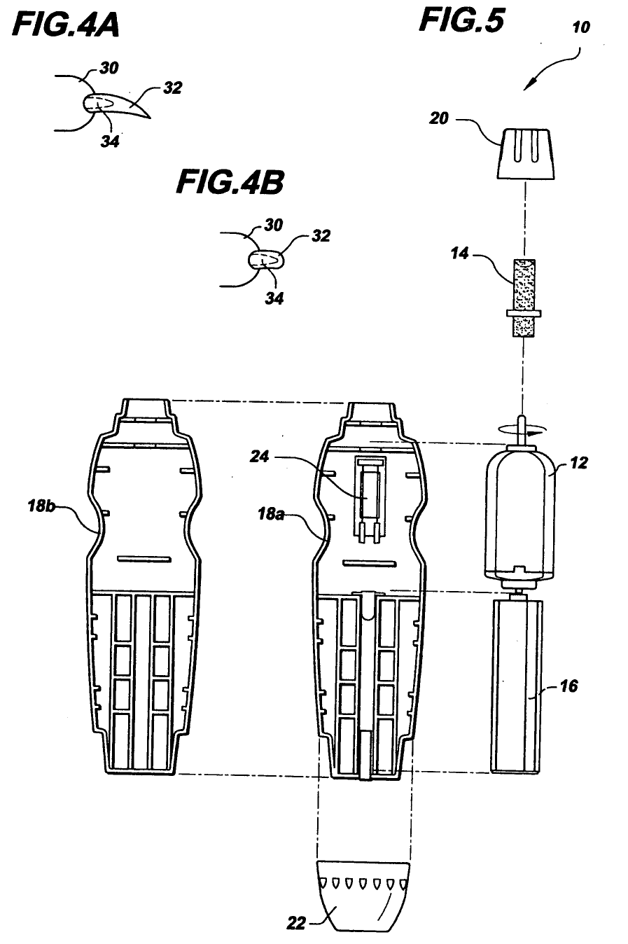

Referring now to FIGS. 1-5 as in one embodiment shown is a groomer 10. The groomer 10 is of a ergonomically constructed, handheld, portable, battery operated powerful groomer 10 used for the safe grooming and trimming of dog, cat or other pet's 26 nails 32 and may also be used for the safe trimming of pet birds beaks and claws by using a safe grinding method powered by a one or two speed motor 12 to drive a removable and changeable concave grinding stone 14 that is safely housed inside a cone shaped cover 20 with a top opening to which the nail 32 is gently inserted by a person 28.

The overall groomer 10 may be approximately 6″ long and 1.5″ wide. A powerful one or two speed motor 12 may be used to drive the removable and changeable concave grinding stone 14. Grinding stone 14 is a removable and changeable concave grinding stone like material of any degree of coarseness. Shown is a removable, replaceable standard “AA” battery 16. An ergonomically constructed lightweight durable front body 18a of the groomer 10 may be used to house a mechanism to generate power to the grinding stone 14.

An ergonomically constructed lightweight durable back body 18b of the groomer 10 may be used to house the mechanism to generate power to the concave grinding stone 14. Both front and back body 18a and 18b may be made of plastic. A cone shaped cover 20 is over the concave grinding stone 14 with an opening access thru the top, large enough for a person 28 to gently insert the animal nail 32 for trimming. Shown is a cone shaped battery 16 access cover 22. A variable speed or on/off switch 24 is shown. Shown are any pet 26 and a person 28. Shown is any pet's paw 30 and any pet's nail 32: A quick 34 is inside the nail 32.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A portable animal groomer comprising:
a removable and replaceable concave grinding stone;
a motor to drive the stone at a speed; and
a cone shaped cover surrounding the stone with a top opening to receive an animal part to be groomed without hitting the quick while grinding material off the animal part.

2. The device of claim 1, wherein the animal part is a selected one of a nail and beak.

3. The device of claim 1, wherein the concave grinding stone is hollowed out at one end in a cup shape to round off the animal part.

4. The device of claim 1, wherein the motor has two speeds.

5. The device of claim 1 wherein the motor has a slow speed in the range of 2000 to 2800 rpm.

6. The device of claim 1 wherein the motor has a fast speed in the range of 3000 to 4000 rpm.

7. The device of claim 1 wherein a the motor has a slow speed in the range of 2000 to 2800 rpm and the motor has a fast speed in the range of 3000 to 4000 rpm a switch selects between the two speeds and an off position.

8. A portable animal groomer comprising:
a removable and replaceable concave grinding stone;
at least one rotational speed of the stone the stone driven by a motor;
a cone shaped cover surrounding the stone with a top opening to receive an animal part to be groomed without hitting the quick while grinding material off the animal part; and
a front body and a back body to house at least one battery and the motor.

9. The device of claim 8, wherein the animal part is a selected one of a nail and beak.

10. The device of claim 8, wherein the concave grinding stone has a concave end the concave end has an opening shaped like one half an inner surface of a sphere to round the animal part.

11. The device of claim 8, wherein the motor has two speeds.

12. The device of claim 8 wherein the motor has a slow speed in the range of 2000 to 2800 rpm.

13. The device of claim 8 wherein the motor has a fast speed in the range of 3000 to 4000 rpm.

14. The device of claim 8 wherein a the motor has a slow speed in the range of 2000 to 2800 rpm and the motor has a fast speed in the range of 3000 to 4000 rpm.

15. The device of claim 8, wherein the cover is connected to both the front and back body.

16. The device of claim 8 wherein a cone shaped cover connects to the front and back cover and secures the at least one battery.

17. A method of removing material from animal parts comprising:
placing the animal part inside a concave grinding stone;
grinding material from the animal part while maintaining a quick in normal condition
rounding the animal part; and
removing the animal part from the concave grinding stone.

18. The method of claim 17 wherein the concave grinding stone is surrounded by a cover.

19. The method of claim 17 wherein the animal part is a selected one of a nail, claw and beak.

20. The method of claim 17 wherein the grinding can be done at two different speeds.
